(19) United States
(12) Patent Application Publication
(10) Pub. No.: US 2003/0057815 A1
(43) Pub. Date: Mar. 27, 2003

(54) Light bulb with safety coil positioning structure

(76) Inventor: Jung-Ting Lin, Taipei City (TW)

Correspondence Address: LIN, JUNG-TING, P.O. BOX 7-820, TAIPEI, TW

(21) Appl. No.: 09/962,295

(22) Filed: Sep. 26, 2001

(51) Int. Cl. H01J 1/90

(52) U.S. Cl. 313/277

(57) ABSTRACT

Light bulb with safety coil positioning structure This invention relates to a light bulb with safety coil positioning structure, more particularly a light bulb with an angled section at the front conductive wires above the core pillar's bead, such that the two conductive wires show a pair of opposing inwardly bent angled-surface with a short distance apart, in order to let the two conductive wires be wrapped around by two safety coils at the opposing inwardly bent angled-surface. Therefore, the safety coils can be fixed in position by the two opposing inwardly bent angled-surface with a short distance apart and is prevented from sliding up and down or falling out of position as a result of the loosening of their parallel surfaces, and cause the malfunction of their safety feature.

### BACKGROUND OF THE INVENTION

As in the manufacturing process of bulbs for Christmas lights, the conductive wires above the bead of the core pillar must be wrapped with safety coils for its production, which process limits the automation of its process, and must be done by wrapping around the two conductive wires with a specific number of times and then tightening the wire before pulling it until it severs, unlike the manual wrapping process that uses the fingers to wrap the ends of the coils around one of the wires and form a hook before pulling it until it severs, therefore if the process of wrapping the coils around the conductive wires is subjected to any vibrations, the previously wrapped safety coils will become loosened as a result of deformation in the coiling and wrapping procedure, and further causing the previously wrapped safety coil above the bead on the completed product to gradually fall off and slide away after the secondary sealing of the opening and the vacuum procedures, and completely losing the added function of the safety coil.

### SUMMARY OF THE INVENTION

The main object of this invention is to provide a light bulb with safety coil positioning structure, mainly through having a bent angled section on the front conductive wires above the bead of the core pillar, facilitating the feature of the two conductive wires to show a pair of opposing inwardly bent angled surfaces with a short distance apart, and assuring the actual functional effect of securing the safety coil in a position so that it will not fall or slide off.

The secondary objective of this invention is to provide a light bulb with safety coil positioning structure, and through having the safety coils wrapped around the front conducive wires above the bead of the core pillar at the inwardly bent angled-surface, so that the inwardly bent angled surfaces with a short distance apart may assure the fixed positioning of the safety coils and is prevented from sliding up and down or falling out of position as a result of the loosening of their parallel surfaces, and cause the malfunction of their safety feature.

### BRIEF DESCRIPTION OF THE DRAWINGS

FIG. 1 is shows the illustrative diagram of the light bulb with safety coil positioning structure of this invention;

FIG. 2 is shows the core pillar of light bulb with safety coil positioning structure of this invention;

FIG. 3 is shows an example implementation of the secured safety coil structure according to this invention;

FIG. 4 is shows illustrates a traditional core pillar and shows its comparison with that of this invention.

### DETAILED DESCRIPTION OF THE PREFERRED EMBODIMENT

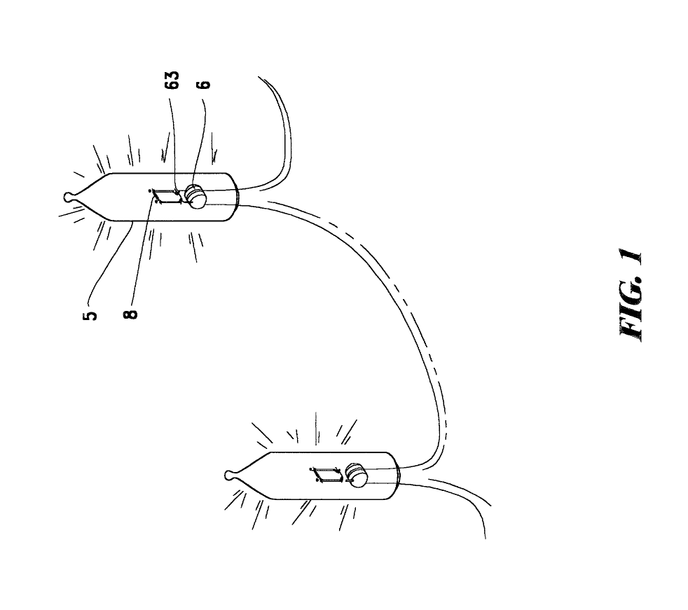

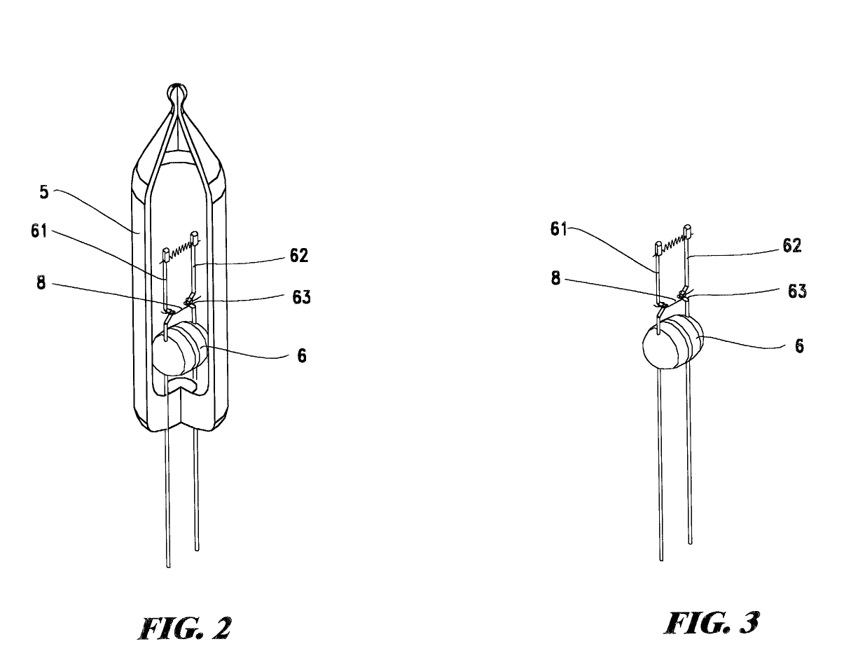

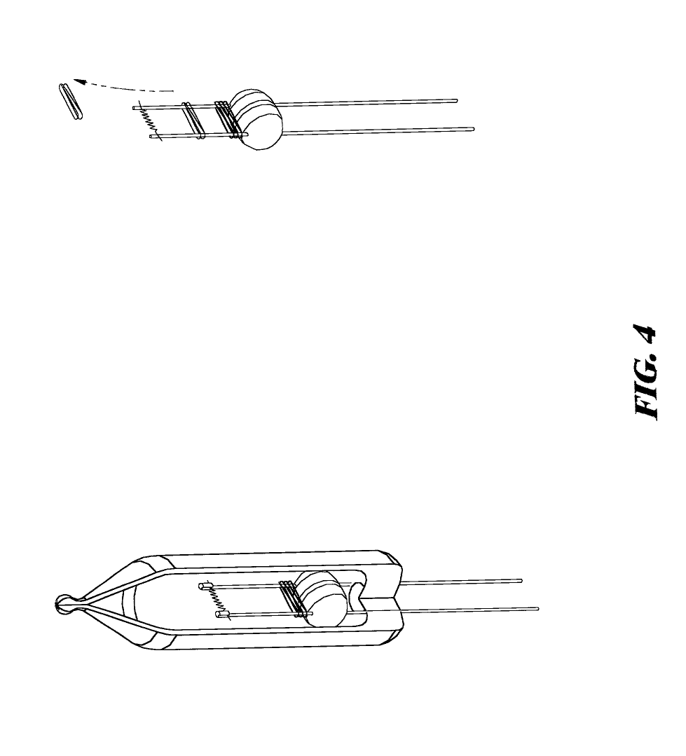

With reference to the drawings and in particular to FIG. 1 through 6. The innovation of the light bulb with safety coil positioning structure of this invention is mainly characterized in that an integral core pillar is sealed within a bulb shell (5), and the core pillar has two conductive wires (61, 62) forming a pair of grooves at the bent angled section (63), such that the grooves at the bent angled sections on the two conductive wires form a pair of inwardly bent section of opposing angled surfaces with a short distance apart. When a safety coil (8) is wrapped around the two opposing inwardly bent angled grooves, the distance between the wrapped safety coil is shorter than the two parallel conductive wires, and through the assurance of a fixed position provided by the pair of inwardly angled surfaces with a short distance apart, the safety coils are prevented from sliding up and down or be loosened or fall off and cause the malfunction of their safety feature, achieving the practical effectiveness in the feature of assuring the safety coils are rendered a fixed position and prevented from sliding and falling off.

It is worth mentioning that the implementation and operation of the safety coil positioning structure of this innovation in invention could be functioned as a single safety coil being wrapped several times at the groove of the bent angled section of one of the conductive wires, and then cross-over to the groove of the opposite bent angled section of the other conductive wire, wrapped several times to secure its position, thus forming a single safety coil between the two conductive wires, and may have several more parallel wrappings of the safety coil between the grooves of the bent angled sections of the two conductive wires, which can have the same functional benefit of fixing the safety coil in position.

I claim:

1. A type of light bulb with safety coil positioning structure, comprising of a groove at the bent angled section at the front conductive wires above the core pillar's bead, such that the two conductive wires form a pair of opposing angled surfaces with a short distance apart, and provide the assurance of fixed position of the safety coils, and prevent them from sliding up and down or falling out of position as a result of the loosening of their parallel surfaces, achieving the practical effectiveness in the feature of assuring the safety coils are rendered a fixed position and prevented from sliding and falling off.

2. A type of light bulb with safety coil positioning structure, which could be functioned as a single safety coil being wrapped several times at the groove of the bent angled section of one of the conductive wires, and then cross-over to the groove of the opposite bent angled section of the other conductive wire, wrapped several times to secure its position, thus forming a single safety coil between the two conductive wires.
